(19) United States
(12) Patent Application Publication
(10) Pub. No.: US 2008/0240561 A1
(43) Pub. Date: Oct. 2, 2008

(54) IMAGE PROCESSING APPARATUS

(75) Inventor: Toyoaki Kuwahara, Kamiina-gun (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 12/056,015

(22) Filed: Mar. 26, 2008

(30) Foreign Application Priority Data
Mar. 27, 2007 (JP) 2007-081535

(51) Int. Cl. G06K 9/00

(52) U.S. Cl. 382/168

(57) ABSTRACT

An image processing apparatus creates a brightness histogram of image data including a plurality of pixel data composed of a plurality of color data. The image processing apparatus includes: a histogram storage memory which stores number information used to specify the number of pixels classified by the similar colors by classification; an address generating unit which generates address data by masking some of the color data included in the pixel data; and a histogram creating unit which accesses the histogram storage memory and creates the brightness histogram by incrementing the number information specified as an address generated by the address generating unit.

### BACKGROUND

1. Technical Field

The present invention relates to a process of creating a brightness histogram, and particularly, a technique for speeding up the process of creating the brightness histogram.

2. Related Art

In the past, an image processing apparatus capable of processing printing image data subjected to a digital process such as pixel correction, gamma correction, color space conversion, or color suppression after A/D conversion of image data to be processed. In order to improve image quality, most image processing apparatuses create a brightness histogram indicating the generation number of times of a brightness value of the image data to be processed. The created brightness histogram is used for a brightness adjustment process, a filtering process, and an image process of white balance or the like of the image data to be processed.

Such a process of creating the brightness histogram is performed by software. For example, JP-A-7-085275 discloses a method of extracting a specified area of the image data using the brightness histogram made by the use of the software.

However, recently, the gray scale and the size of the image data processed by the image processing apparatus have been inclined to become increased. Accordingly, if the process of creating the brightness histogram is performed by software, much time may be necessary. Therefore, an image processing apparatus capable of performing the process of creating the brightness histogram by use of hardware has been developed. For example, JP-A-2002-369034 discloses a technique capable of performing the process of creating the brightness histogram by use of hardware using a memory for a lookup table.

However, the process of creating the brightness histogram has to be performed more rapidly in preparation for increase in the gray scale value and the image size of the image data processed by the image processing apparatus.

### SUMMARY

An advantage of some aspects of the invention is that it provides a technique for speeding up a process of creating brightness histogram performed by an image processing apparatus.

According to an aspect of the invention, there is provided an image processing apparatus which creates a brightness histogram of image data including a plurality of pixel data composed of a plurality of color data. The image processing apparatus includes: a histogram storage memory which stores number information used to specify the number of pixels classified by every similar color; an address generating unit which generates address data by masking some of the color data included in the pixel data; and a histogram creating unit which accesses the histogram storage memory and creates the brightness histogram by incrementing the number information specified as an address generated by the address generating unit.

With such a configuration, it is possible to speed up the brightness histogram creating process performed by the image processing apparatus.

### BRIEF DESCRIPTION OF THE DRAWINGS

The invention will be described with reference to the accompanying drawings, wherein like numbers reference like elements.

FIG. 1 is a diagram illustrating a configuration of functions of an image processing apparatus according to the embodiment.

FIG. 2 is a diagram illustrating a configuration of hardware of a histogram creating unit.

FIG. 3 is a diagram for explaining an address converting process of RGB data.

FIG. 4 is a diagram for explaining the address converting process of Lab data.

FIG. 5 is a diagram for explaining the address converting process of Yuv data.

FIG. 6A is a diagram for explaining a configuration of a histogram storage memory. FIG. 6B is a graph illustrating a brightness histogram.

FIG. 7 is a diagram illustrating an example of a hardware configuration of the image processing apparatus.

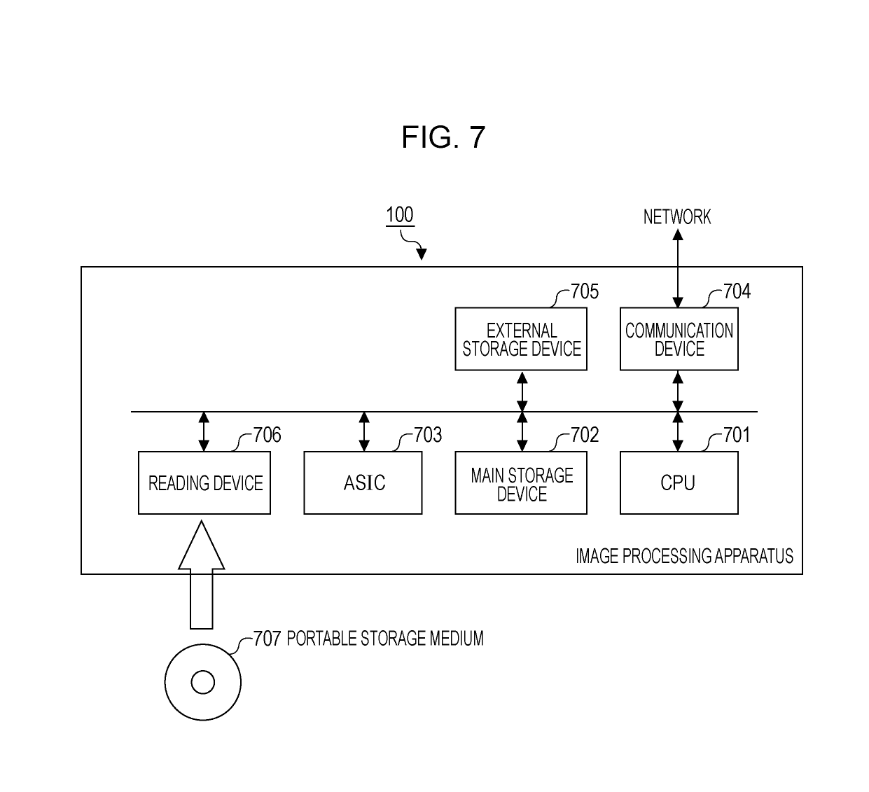

FIG. 8 is a flowchart for explaining an image process.

FIG. 9 is a flowchart for explaining a histogram creating process.

### DESCRIPTION OF EXEMPLARY EMBODIMENTS

Hereinafter, an embodiment of the invention will be described with reference to the drawings.

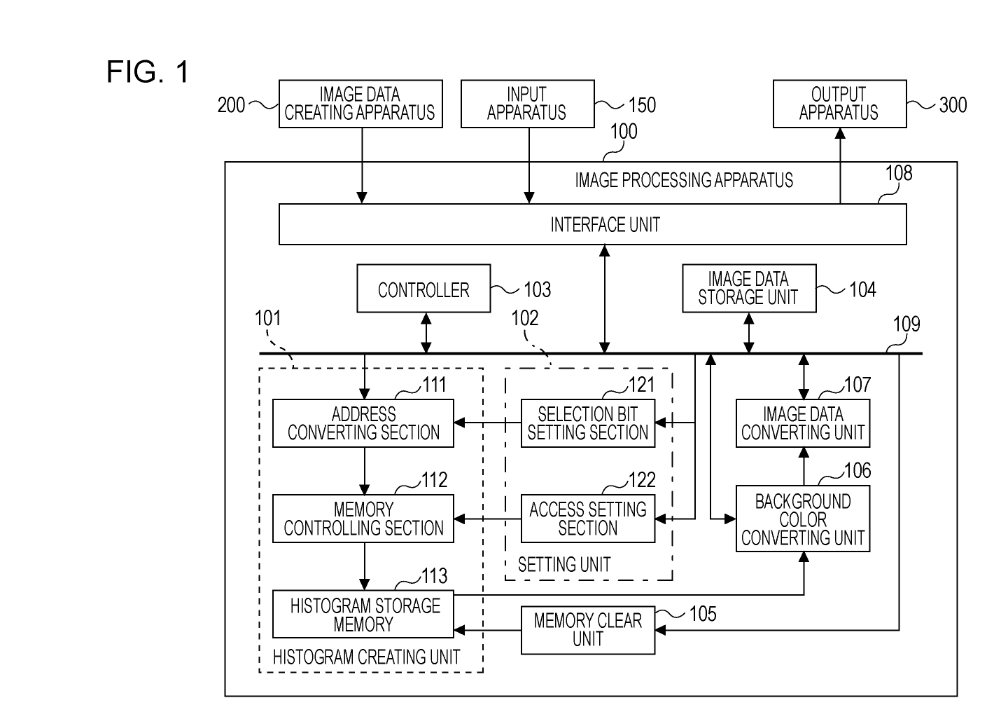

FIG. 1 is a block diagram illustrating an example configuration of an image processing apparatus 100 according to the embodiment of the invention.

The image processing apparatus 100 is an apparatus which creates a brightness histogram used to correct and process image data of a printing target. An image data creating apparatus 200, an output apparatus 300, and an input apparatus 150 are connected to the image processing apparatus 100.

In this case, the image data generating apparatus 200 is a general scanner apparatus which creates image data. A program for scanning images, a program for performing communication with the image processing apparatus 100, and the like are stored in the image data creating apparatus 200. The image data generating apparatus 200 can transmit the image data created by scanning in accordance with the program to the image processing apparatus 100.

The output apparatus 300 is a general printer apparatus which prints printing data. For example, a laser printer as the output apparatus 300 includes a laser irradiation mechanism, a photosensitive drum, a sheet-feeding mechanism, and the like. In addition, a program for performing communication with the image processing apparatus 100, a program for controlling a printing process, and the like are stored in the output apparatus 300. The output apparatus 300 can print the printing data transmitted from the image processing apparatus 100.

The input apparatus 150 can be a keyboard, a mouse, or the like. A user can instruct the image processing apparatus 100 by operating the input apparatus 150.

The image processing apparatus 100 connected to the above-mentioned external apparatuses creates the brightness histogram of the image data transmitted from, for example, the image data creating apparatus 200. The image processing apparatus 100 corrects and processes the image data on the basis of the created brightness histogram to create the printing data. The image processing apparatus 100 transmits the created printing data to the output apparatus 300 to allow the output apparatus 300 to perform printing.

The image processing apparatus 100 includes a histogram creating unit 101, a setting unit 102, a controller 103, an image data storage unit 104, a memory clear unit 105, a background color converting unit 106, an image data converting unit 107, an interface unit 108, and a bus 109.

The image data as a printing target is stored in the image data storage unit 104. For example, the image data acquired from the image data generating apparatus 200 and image data subjected to various converting process by the image data converting unit 107, which is described below, and the like are stored in the image data storage unit 104. In this case, the image data is composed of a plurality of pixel data. For example, the pixel data is RGB pixel data composed of eight-bit red data (hereinafter, referred to as R data), eight-bit green data (hereinafter, referred to as G data), and eight-bit blue data (hereinafter, referred to as B data). Moreover, the image data may be Lab pixel data composed of eight-bit lightness data (hereinafter, referred to as L data), eight-bit color data (hereinafter, referred to as a data) in the range from a green color to a red color, and eight-bit color data (hereinafter, referred to as b data) in the range from a blue color to a yellow color. Moreover, the image data may be Yuv pixel data composed of eight-bit brightness data (hereinafter, referred to as Y data), eight-bit color difference data (hereinafter, referred to as u data) of a red color, and eight-bit color difference data (hereinafter, referred to as v data) of a blue color.

The bus 109 transports data by a parallel transmission method capable of simultaneously transmitting a plurality of bits to a plurality of signal lines. The bus width of the bus 109 is, for example, 32 bits. In this case, four-color data (4×8 bits) are simultaneously transmitted.

The histogram creating unit 101 is a circuit group which creates a histogram of the image data as the printing target. The histogram creating unit 101 includes an address converting section 111, a memory controlling section 112, and a histogram storage memory 113.

Specifically, the histogram creating unit 101 allows the address converting section 111 to convert the image data input from the image data storage unit 104 into an address assigned to the histogram storage memory 113, which is described below. In addition, the histogram creating unit 101 allows the memory controlling section 112 described below to access the histogram storage memory 113 and performs an increment process of data specified as an address converted by the address converting section 111.

In this way, the histogram creating unit 101 can create the histogram of the image data using the histogram storage memory 113.

In the address converting section 111, each color data (for example, the R data, the G data, and the B data) included in one-pixel data has to be simultaneously input. However, since the bus width of the bus 109 is 32 bits, the histogram creating unit 101 includes a selector (not shown) or the like for inputting every one-pixel image data of 32 bits input from the image data storage unit 104 to the address converting section 111.

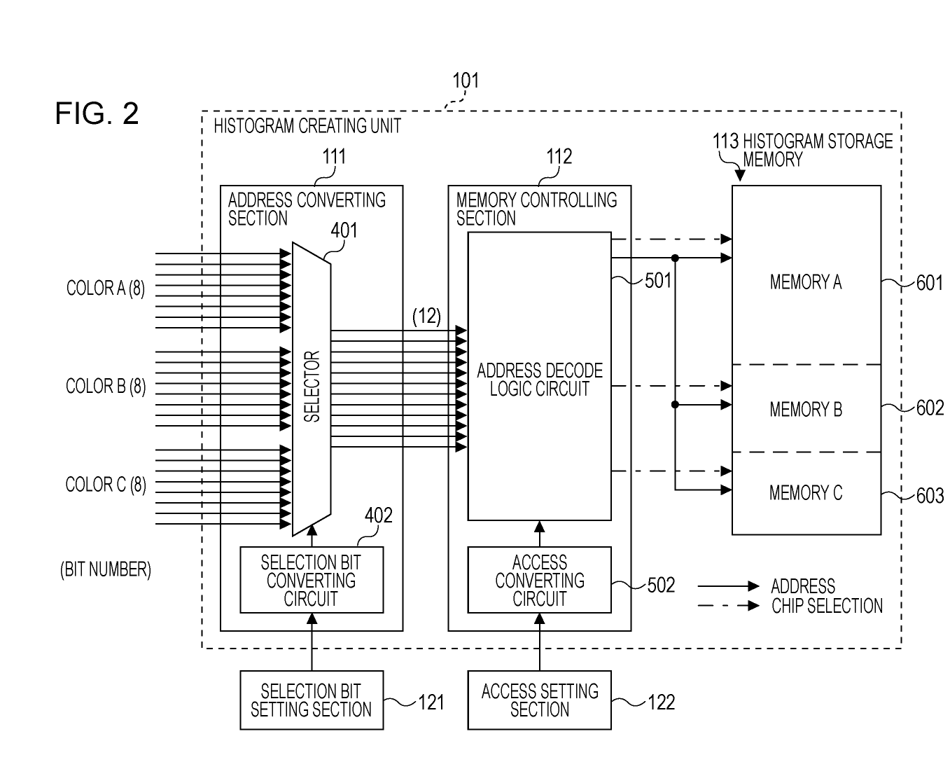

FIG. 2 is a diagram for explaining the configuration of the histogram creating unit 101 in more detail. As shown in FIG. 2, the address converting section 111 includes a selector 401 and a selection bit converting circuit 402.

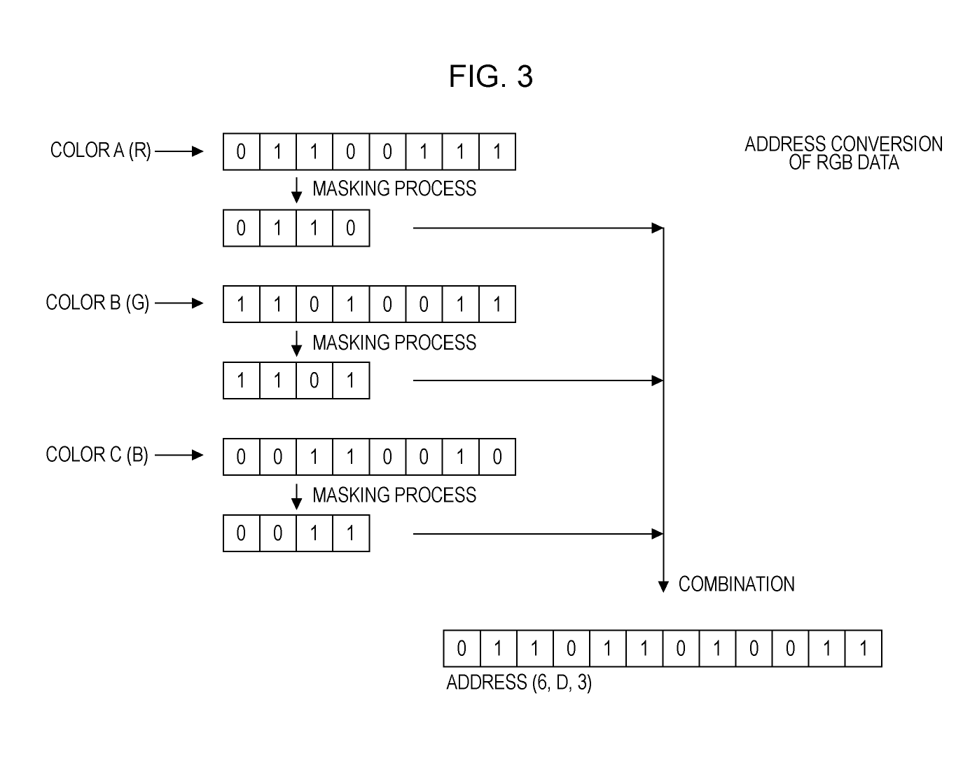

When the RGB pixel data (3×8 bits) of one pixel is input from the image data storage unit 104, the selector 401 converts the RGB pixel data into an address of the 12-bit histogram storage memory 113 to output the RGB pixel data to the memory controlling section 112. Specifically, as shown in FIG. 3, the selector 401 masks low four bits of each color data included in the input RGB pixel data and combines each color data of high four bits to generate an address of the histogram storage memory 113. For example, a process of the selector 401 will be described using an example shown in FIG. 3. First, the R data composed of a “01100111” bit string, the G data composed of an “11010011” bit string, and the B data composed of a “00110010” bit string are input to the selector 401. The selector 401 extracts “0110” (the R data), “1101” (the G data), and “0011” (the B data) which are each high four bits of each color data and combines them to generate a 12-bit string data (hexadecimal number (6, D, 3)) of “011011010011”. The 12-bit string data corresponds to the address of the histogram storage memory 113. In addition, the selector 401 outputs the generated 12-bit address data to the memory controlling section 112.

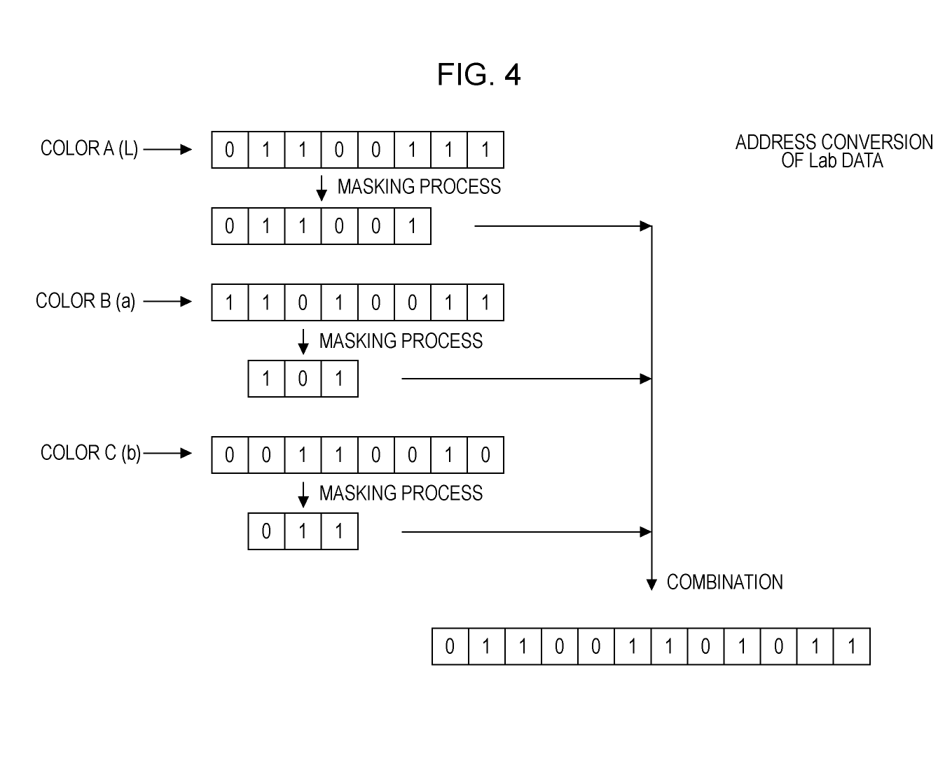

When the Lab pixel data (3×8 bits) of one pixel is input from the image data storage unit 104, the selector 401 converts the Lab pixel data into the address of the 12-bit histogram storage memory 113 to output it to the memory controlling section 112. Specifically, as shown in FIG. 4, the selector 401 masks low two bits of the L data and high one bit and low four bits of each of the a data and the b data of the color data included in the input Lab pixel data to combine each color data and generate the address data. For example, the process of the selector 401 will be described using an example shown in FIG. 4. First, the L data composed of a “01100111” bit string, the a data composed of a “11010011” bit string, and the b data composed of “00110010” bit string are input to the selector 401. The selector 401 extracts “011001” which are high six bits of the L data, “101” which are second to fourth bits of the a data, and “011” which are second to fourth bits of the b data and combines them to generate 12-bit string data of “011001101011”. Subsequently, the selector 401 outputs the generated 12-bit address data to the memory controlling section 112.

In this way, the address conversion of the Lab pixel data can be performed. Accordingly, it is possible to improve brightness resolution of the L data without increase in a memory capacity for storing the address data of the histogram storage memory 113. The a data and the b data of the Lab pixel data is known not to affect human eyes if the a data and the b data are compressed, comparing with the L data. Accordingly, it is possible to create the histogram with good precision by improving the brightness resolution of the L data.

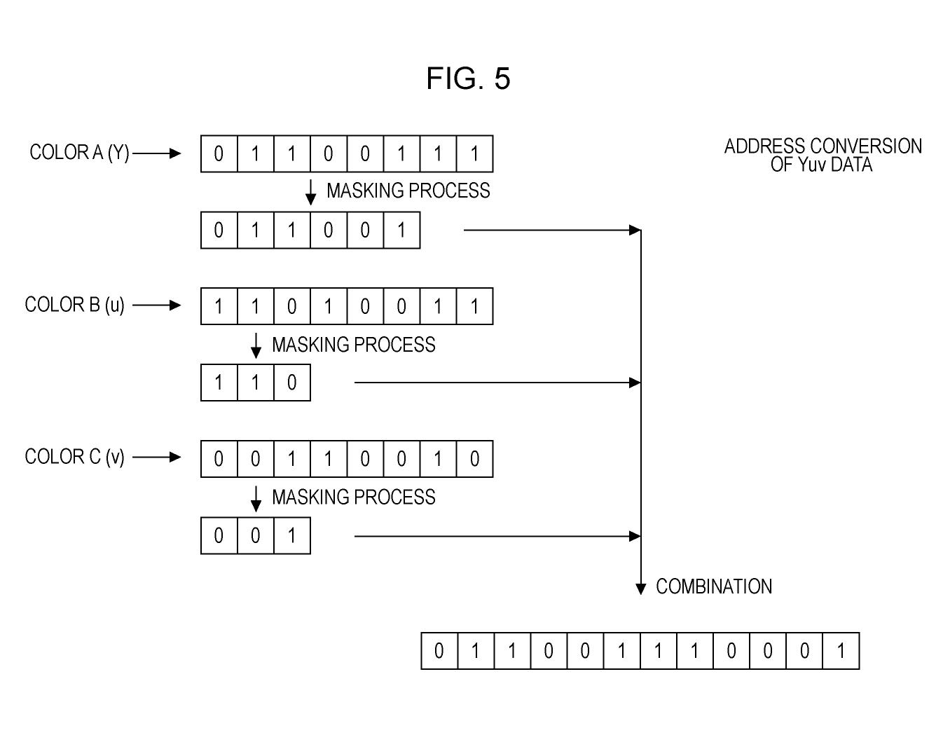

When the Yuv pixel data (3×8 bits) of one pixel is input from the image data storage unit 104, the selector 401 converts the Yuv pixel data into the address of the 12-bit histogram storage memory 113 to output it to the memory controlling section 112. Specifically, as shown in FIG. 5, the selector 401 masks low two bits of the Y data and low five bits of each of the u data and the v data of the color data included in the input Yuv pixel data to combine each color data and generate the address data. For example, the process of the selector 401 will be described using an example shown in FIG. 5. First, the Y data composed of a “01100111” bit string, the u data composed of a “11010011” bit string, and the v data composed of “00110010” bit string are input to the selector 401. The selector 401 extracts “011001” which are high six bits of the Y data, “110” which are high three bits of the u data, and “001” which are high three bits of the v data and combines them to generate 12-bit string data of “011001110001”. Subsequently, the selector 401 outputs the generated 12-bit address data to the memory controlling section 112.

In this way, the address conversion of the Yuv pixel data can be performed. Accordingly, it is possible to create the histogram with good precision by improving the brightness resolution of the Y data by the same reason of the address conversion of the Lab pixel data.

Moreover, when the image data (3×8 bits) of one pixel is input from the image data storage unit 104, the selector 401 converts each 8-bit color data into the address of the 12-bit histogram storage memory 113 to output it to the memory controlling section 112. Specifically, the selector 401 generates 12-bit address data using each 8-bit color data composed of the input pixel data in sequence of color elements. In this case, the sequence of the color elements refers to a sequence of color A data, color B data, and color C data, for example. High four bits of the 12 bits become invalid data. The selector 401 sequentially outputs the three types of the generated 12-bit address data to the memory controlling section 112.

In FIG. 2, the selection bit converting circuit 402 generates a signal used to specify bits for masking each color data by the selector 401 on the basis of the signal supplied from a selection bit setting section 121 described below. For example, the selection bit converting circuit 402 generates the signal used to mask low four bits of each color data to control the selector 401 when the selector 401 generates the address data from the RBG pixel data. In addition, the selection bit converting circuit 402 generates the signal used to mask low two bits of the L data and high one bit and low four bits of each of the a data and the b data to control the selector 401 when the selector 401 generates the address data from the Lab pixel data. In addition, the selection bit converting circuit 402 generates the signal used to mask low four bits of the Y data and low five bits of each of the u data and the v to control the selector 401 when the selector 401 generates the address data from the Yuv pixel data. In addition, the selection bit converting circuit 402 generates a signal used to add the 4-bit invalid data to each 8-bit color data in a predetermined sequence when each address data is created from each color data to control the selector 401.

As shown in FIG. 2, the memory controlling section 112 includes an address decode logic circuit 501 and an access converting circuit 502.

The address decode logic circuit 501 can create a histogram of the image data by incrementing data stored in the histogram storage memory 113. At this time, the address decode logic circuit 501 can create one dimensional histograms of all color elements and a three dimensional histogram of each color element.

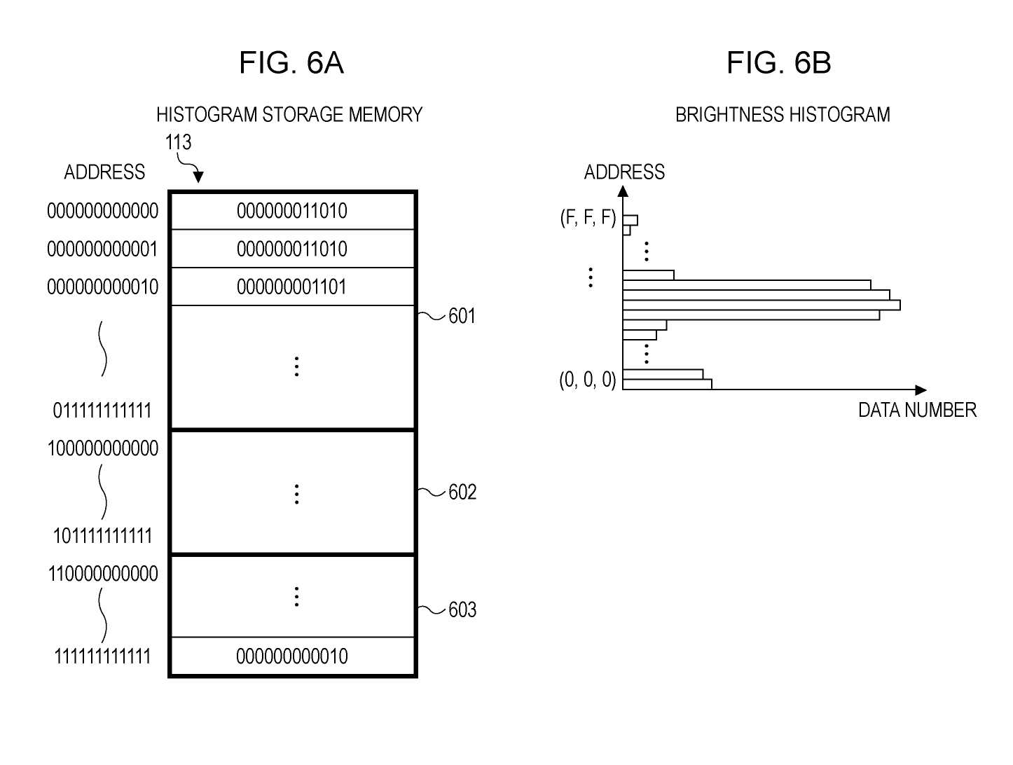

FIG. 6A is a diagram illustrating the histogram storage memory 113 used to create a histogram. As shown in FIG. 6A, the histogram storage memory 113 includes a memory A601 composed of 2⁸(=2048) sectors, a memory B602 composed of 2⁴(=1024) sectors, and a memory C603 composed of 2⁴(=1024) sectors. When the one dimensional histogram is created, it is not necessary to divide the histogram storage memory 113 into three memories (or areas). However, when the three dimensional histogram is created, as shown in FIG. 6A, it is desirable to divide the histogram storage memory 113 into three memories. That is because it is necessary to retrieve data of each color element from the histogram storage memory 113 when various processes (a compression process, a correction process, etc.) of each color element are performed.

An address corresponding to the address data generated by the selector 401 is configured to be assigned to each sector. In addition, an address with high four bits of “0***” is assigned to each sector of the memory A601. An address with high four bits of “10**” is assigned to each sector of the memory B602. An address with high four bits of “11**” is assigned to each sector of the memory C603. In this case, “*” means that any value of 0 or 1 can be taken.

The one dimensional histogram can be created using the histogram storage memory 113. For example, the address decode logic circuit 501 shown in FIG. 2 accesses the histogram storage memory 113 and acquires data stored in the sector specified by the input address data when the 12-bit address data is input from the selector 401. At this time, the 12-bit address data successively input to the address decode logic circuit 501 becomes an address corresponding to one memory of the memory A601, the memory B602, and the memory C603 in an irregular sequence. Accordingly, the address decode logic circuit 501 can simultaneously access the three memories at most to perform a read/write process. At this time, as shown by a dashed line in FIG. 2, the address decode logic circuit 501 supplies a chip select signal used to specify a memory to the histogram storage memory 113. Next, the address decode logic circuit 501 increments the acquire data and stores the incremented data to the sector of a data acquiring source. Such a process is performed for all pixels composing the image data of one surface. The data used to specify the number of pixels classified by similar colors in the image data of one surface is stored in the histogram storage memory 113. For example, the one dimensional histogram created in the histogram storage memory 113 is the same as the brightness histogram as shown in FIG. 6B.

Specific data stored in each sector is the 12-bit string data as shown in FIG. 6A. The reason why the 12 bits are used is that a value stored in one sector of the histogram storage memory 113 becomes the largest value “111111111111” in a case in which all pixel of the image data of one surface are the same color.

When the three dimensional histogram is created using the histogram storage memory 113, for example, the address decode logic circuit 501 shown in FIG. 2 accesses the histogram storage memory 113 in a sequence in which the 12-bit address data is input from the selector 401 and acquires the data stored in the specific sector specified by the input address data. At this time, the 12-bit address data successively input to the address decode logic circuit 501 is input in a regular sequence of the corresponding color elements. In addition, the address decode logic circuit 501 accesses the corresponding memory in a regular sequence and has to perform the read/write process. At this time, the address decode logic circuit 501 supplies the chip select signal used to specify a memory to the histogram storage memory 113 as shown by the dashed line of FIG. 2. In this case, the address decode logic circuit 501 converts the chip select signal on the basis of a counter value supplied from the access converting circuit 502 described below. Next, the address decode logic circuit 501 increments the acquire data and stores the incremented data to the sector of the data acquiring source. Such a process is performed for all pixels composing the image data of one surface. The data used to specify the number of pixels classified by similar colors in the image data of one surface is stored in the histogram storage memory 113.

In FIG. 2, the access converting circuit 502 included in the memory controlling section 112 generates a control signal used for the address decode logic circuit 501 to create the one dimensional histogram or a control signal used to create the three dimensional histogram on the basis of the signal supplied from an access setting section 122 described below. For example, the access converting circuit 502 includes a counter. In a case in which the address decode logic circuit 501 creates the one dimensional histogram, valid data is not supplied to the address decode logic circuit 501. In addition, in a case in which the address decode logic circuit 501 creates the three dimensional histogram, the access converting circuit 502 increments the counter whenever the address data is input from the selector 401. The access converting circuit 502 performs resetting at the time when a value of the counter reaches a “3” value. The access converting circuit 502 supplies the signal used to specify the value of the counter to the address decode logic circuit 501.

In FIG. 1, the setting unit 102 performs setting of the histogram creation performed by the histogram creating unit 101. The setting unit 102 includes the selection bit setting section 121 and the access setting section 122.

The selection bit setting section 121 sets converting of a selection bit in the selector 401 described above. For example, for the selection bit converting circuit 402, the selection bit setting section 121 performs setting of the histogram creation on the basis of one pixel data of the RGB pixel data, the Lab pixel data, and the Yuv pixel data. In addition, for the selection bit converting circuit 402, the selection bit setting section 121 performs setting of determining one of the one dimensional histogram and the three dimensional histogram. Specifically, a signal used to specify setting contents supplied from the controller 103 described below is converted into a signal which can be analyzed by the selection bit converting circuit 402.

The access setting section 122 performs setting of converting access to the histogram storage memory 113 in the above-described address decode logic circuit 501. For example, for the access converting circuit 502, the access setting section 122 performs setting of determining one of the one dimensional histogram and the three dimensional histogram. Specifically, a signal used to specify setting contents supplied from the controller 103 described below is converted into a signal which can be analyzed by the access converting circuit 502.

The controller 103 transmits a command signal to each unit included in the image processing apparatus 100 to perform overall controlling of each unit or data transmission between the units. Specifically, the controller 103 receives an instruction signal supplied from the input apparatus 150 through the interface unit 108 described below and supplies a command signal corresponding to the instruction signal to each unit. For example, the controller 103 stores the image data acquired from the image data generating apparatus 200 to the image data storage unit 104 through the interface unit 108. The controller 103 transmits the image data stored in the image data storage unit 104 to the histogram creating unit 101 through the bus 109 in accordance with an instruction signal from the input apparatus 150. The controller 103 supplies a signal used to notify setting contents to the setting unit 102 in accordance with an instruction signal from the input apparatus 150. The controller 103 supplies an instruction signal for resetting the data stored in the histogram storage memory 113 to the memory clear unit 105 described below. The controller 103 performs setting of an image process of a high-definition/low-speed mode or a low-definition/high-speed mode in accordance with an instruction signal from the input apparatus 150. Specifically, the controller 103 supplies the image data to the background color converting unit 106 through the histogram creating unit 101 when it receives the instruction signal for setting the high-definition/low-speed mode from the input apparatus 150. On the other hand, the controller 103 supplies the image data to the background color converting unit 106 through no histogram creating unit 101 when it receives the instruction signal for setting the low-definition/high-speed mode from the input apparatus 150.

The memory clear unit 105 accesses the histogram storage memory 113 to erase the data stored in the histogram storage memory 113. For example, the memory clear unit 105 performs erasing of data stored in the histogram storage memory 113 when an instruction signal is supplied from the controller 103. The instruction signal from the controller 103 is supplied at timing of starting the histogram creation.

The background converting unit 106 performs converting of unifying a background color of the image data to the same color (for example, a white color) with reference to the histogram created by the histogram creating unit 101 when the high-definition/low-speed mode is set. Specifically, the background converting unit 106 accesses the histogram storage memory 113 to acquire an address corresponding to the sector storing data having the maximum value. In this case, the background converting unit 106 may acquires an address corresponding the sector which does not store data having the maximum value, but stores data having a reference value or more. In this case, the reference value can be a value evaluated by “(a mean value μ)+(a standard deviation σ)×(a coefficient k)”. In this case, the coefficient k is stored beforehand in an external storage device 705. The background converting unit 106 reads the coefficient k to evaluate the reference value of every image data.

The background converting unit 106 can acquires an address corresponding to the sector storing the data having the maximum value or the reference value or more for every color element when the three dimensional histogram is stored in the histogram storage memory 113.

Next, the background color converting unit 106 reads image data from the image data storage unit 104 to perform color converting of unifying the background color to the same color for the pixels having the color element corresponding to the prior acquired address. In this way the background converting unit 106 performs the color converting of the background color of the image data.

The background converting unit 106 performs converting of unifying a background color of the image data to the same color with reference to the prior set histogram when the low-definition/high-speed mode is set. Specifically, the background converting unit 106 reads a fixation value stored beforehand in the external storage device 705 described below and the image data stored in the image data storage unit 104 to perform the color converting of unifying the background color to the same color for the pixels having the color element identical with the fixation value. In this case, the fixation value is set to a value specifying a color intended to be excluded from the image data (for example, a color in which (R, G, B) with sallowness is (0, F, F)).

The background converting unit 106 stores the image data subjected to the background color converting of the image data to the image data storage unit 104 in accordance with the high-definition/low-speed mode or the low-definition/high-speed mode. At this time, the fact that the background color converting is finished is notified to the image data converting unit 107.

The image data converting units 107 performs processing of performing various conversions of the image data. For example, the image data converting unit 107 converts the image data stored in the image data storage unit 104 into image data of different color space. That is, an RBG image is converted into an Lab image, the RBG image is converted into a Yuv image, or the Lab image is converted into a CMYK image. The image data converting unit 107 performs a compression process, a screen process, and the like of the image data. The image data converting unit 107 creates printing data which can be analyzed by the output apparatus 300 such as a printer on the basis of the image data. The image data converting unit 107 outputs the created printing data to the output apparatus 300 through the interface unit 108.

The interface unit 108 receives connection of the image data generating apparatus 200 or the output apparatus 300 to receive and transmit various data from and to the apparatus. The interface unit 108 is an interface which accepts connection of the input apparatus 150 and receives various types of data from the input apparatus 150. For example, an interface unit 108 may be a USB interface complied with a USB standard. However, the interface unit 108 is not limited to the UBS interface, but may be a network interface such as LAN connected to a network.

The image processing apparatus 100 having the above-described configuration can be embodied as a general computer which includes a CPU 701, a main storage device 702 such as RAM, an ASIC 703 for performing a specific process, a communication device 704 for performing USB communication with the image data generating apparatus 200 and the output apparatus 300, an external storage device 705 such as a hard disk, and a reading device 706 for reading information from a portable storage medium 707 such as CD-ROM or DVD-ROM.

For example, the above-described controller 103 can be embodied as the CPU 701 which loads a predetermined program or data stored in the external storage device 705 to the main storage device 702. The image data storage unit 104 can be embodied as the external storage device 405. The histogram creating unit 101, the setting unit 102, the memory clear unit 105, the background converting unit 106, and the image data converting unit 107 can be embodied as the ASIC 703. The interface unit 108 can be embodied as the communication device 704.

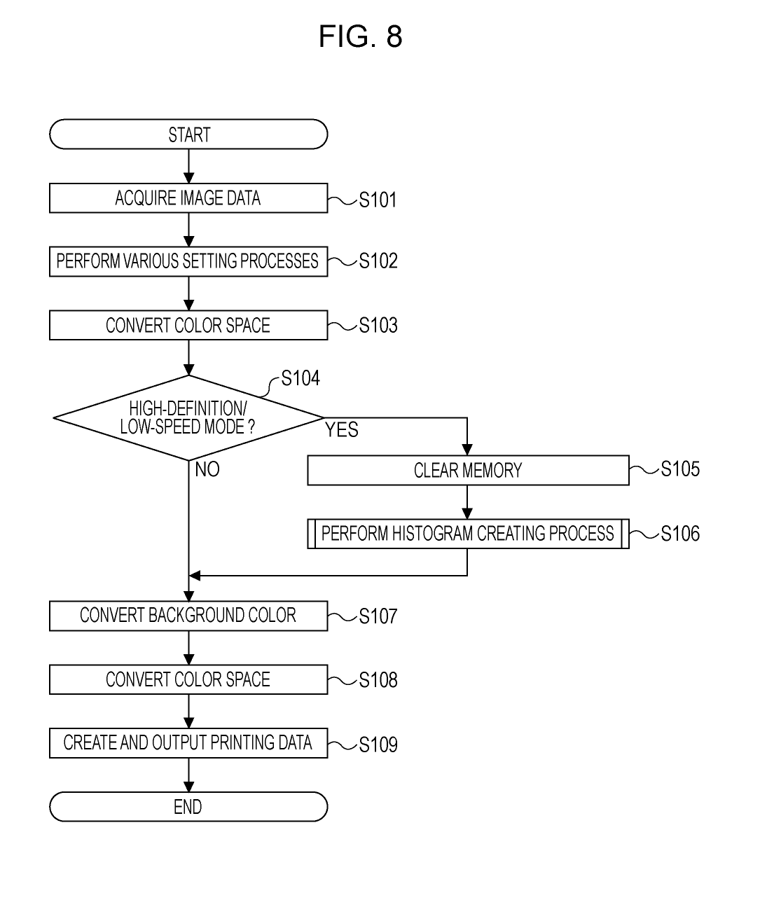

FIG. 8 is a flowchart for explaining an image process performed in the image processing apparatus 100 when the brightness histogram of the image data is created.

The controller 103 of the image processing apparatus 100 starts the image process when an instruction for starting the image process is received from a user.

First, the controller 103 acquires the image data as a printing target from the image data generating apparatus 200 connected to the interface unit 108 (Step S101). Specifically, the controller 103 stores the image data generated by the image data generating apparatus 200 to the image data storage unit 104 through the interface unit 108.

Next, the controller 103 performs various types of setting of the image process (Step S102). Specifically, the controller 103 receives an instruction signal from the input apparatus 150 through the interface unit 108. For example, setting items such as a color space of the image data at the time of creating a histogram, a created histogram type, and an image processing mode are received. As described above, the color space of the image data is selected from, for example, RBG, Lab, and Yuv. The created histogram type is selected from the one dimensional histogram, the three dimensional histogram, and the like. The image processing mode is selected from the high-definition/low-speed mode, the low-definition/high-speed mode, and the like. The controller 103 supplies the signal used to specify the setting contents about the color space to the selection bit setting section 121 and the image data converting unit 107 on the basis of the instruction signal from the input apparatus 150. The controller 103 supplies the signal used to specify the setting contents about the histogram type to the selection bit setting section 121 and the access setting section 122 on the basis of the instruction signal from the input apparatus 150. At this time, the selection bit setting section 121 supplies a signal based on the setting contents to the selection bit converting circuit 402. The access setting section 122 supplies the signal based on the setting contents to the access converting circuit 503.

The controller 103 starts a pipeline process in accordance with the mode of the image process set in Step S102.

The controller 103 allows the image data converting unit 107 to change the color space of the image data (Step S103). Specifically, the controller 103 supplies the image data stored in the image data storage unit 104 to the image data converting unit 107. The image data converting unit 107 converts the color space of the input image data in accordance with the command signal supplied in Step S102. For example, when the color space is set to RGB in Step S102, the image data converting unit 107 converts the input image data into the RGB image. When the color space of the input image data is equal to the set color space, the process in Step S103 is not performed.

When the image processing mode is set to the high-definition/low-speed mode (Yes in Step S104), the image data converting unit 107 supplies the image data having the converted color space to the histogram creating unit 101. Alternatively, when the image processing mode is set to the low-definition/high-speed mode (No in Step S104), the image data converting unit 107 supplies the image data having the converted color space to the image data storage unit 104. At this time, the image data converting unit 107 supplies the background converting unit 106 with a signal for notifying that the color space converting process ends.

In Step S105, the controller 103 clears the data stored in the histogram storage memory 113 before creating the histogram to the histogram creating unit 101 (Step S105). For example, the controller 103 supplies a command signal for memory clear to the memory clear unit 105.

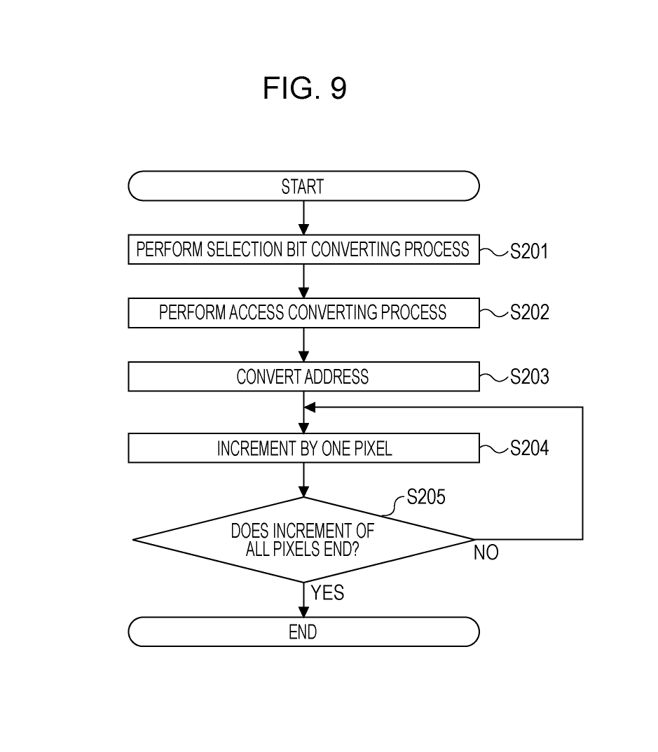

In Step S105, the histogram creating unit 101 creates a histogram of the image data. The histogram creating process will be described with reference to the flowchart in FIG. 9.

On the other hand, in Step S107, the background color converting unit 106 receives notification from the image data converting unit 107 and accesses the image data storage unit 104 to perform a converting process of unifying the background color to the same color (Step S107). At this time, the background converting unit 106 stores the image data having the converted background color to the image data storage unit 104. In addition, the background converting unit 106 supplies the image data converting unit 107 with a signal for notifying that the background color converting process ends.

In Step S107, when the histogram creating process is performed in Step S106, the background converting unit 106 performs the converting process of unifying the background color to the same color with reference to the histogram storage memory 113.

The image data converting unit 107 receives notification from the background color converting unit 106 and accesses the image data storage unit 104 to convert the image data having converted background color into the image data of the color space used in printing (Step S108). For example, the image data converting unit 107 converts the image data having the converted background color in Step S106 into CMYK image data.

Subsequently, the image data converting unit 107 performs the compression process, the screen process, and the like of the image data performed in Step S107 to generate printing data which can be analyzed by the output apparatus 300 (Step S109). Subsequently, the image data converting unit 107 transmits the generated printing data to the output apparatus 300 through the interface unit 108. After the pipeline process ends, the controller 103 terminates the image process.

FIG. 9 is a flowchart for explaining the histogram creating process performed by the histogram creating unit 101.

In Step S106 of FIG. 8, the histogram creating unit 101 starts the histogram creating process when the image data is supplied from the image data converting unit 107.

First, the selection bit converting circuit 402 of the address converting section 111 performs a selection bit converting process in accordance with a signal supplied from the selection bit setting section 121 (Step S201). For example, the selection bit converting circuit 402 generates a signal used to specify bits for masking each color data input to the selector 401.

Next, the access converting circuit 502 of the memory controller section 112 performs an access converting process in accordance with the access setting section 122 (Step S202). For example, the access converting circuit 502 generates a control signal used for the address decode logic circuit 501 to create the one dimensional histogram or a control signal for the address decode logic circuit 501 to create the three dimensional histogram.

Assuming that each converting process ends in Step S201 and Step S202, the selector 401 converts the image data input from the image data converting unit 107 to an address assigned to the histogram storage memory 113 in accordance with the signal generated in Step S201 (Step S203). The selector 401 outputs the converted and generated address data to the address decode logic circuit 501.

The address decode logic circuit 501 increments the data of the histogram storage memory 113, which is specified as address data input from the selector 401, in accordance with the signal generated in Step S202 (Step S204). For example, in a case in which the signal generated in Step S202 is a signal for creating the three dimensional histogram, the address decode logic circuit 501 creates the three dimensional histogram.

The address decode logic circuit 501 repeats the above-described process until the increment of the data of the histogram storage memory 113, which is specified as the address data input from the selector 401 ends (No in Step S205). In this way, the address decode logic circuit 501 can create the histogram on all pixels included in the image data of one surface. Alternatively, when the process in Step S204 ends for all address data (Yes in Step S205), the histogram creating unit 101 terminates the histogram creating process.

The invention is not limited to the above-described embodiment, but may be modified in various forms.

For example, the image data generating apparatus 200 is configured as the scanner according to the above-described configuration. However, the invention is not limited thereto. For example, the image data generating apparatus may be configured as any apparatus such as a digital camera or a cellular phone as long as the apparatus can generate image data.

In this embodiment, the output apparatus 300 is configured as the printer. However, the invention is not limited thereto. For example, the output apparatus may be configured as any apparatus such as a display or a portable audio player as long as the apparatus can output (or display) corrected and processed data using the histogram created by the image processing apparatus 100.

The entire disclosure of Japanese Patent Application No. 2007-081535, filed Mar. 27, 2007 is expressly incorporated by reference herein.

What is claimed is:

1. An image processing apparatus which creates a brightness histogram of image data including a plurality of pixel data composed of a plurality of color data, the image processing apparatus comprising:
a histogram storage memory which stores number information used to specify the number of pixels classified by every similar color;
an address generating unit which generates address data by masking some of the color data included in the pixel data; and
a histogram creating unit which accesses the histogram storage memory and creates the brightness histogram by incrementing the number information specified as an address generated by the address generating unit.

2. The image processing apparatus according to claim 1, wherein the pixel data is RGB pixel data composed of R data, G data, and B data.

3. The image processing apparatus according to claim 1, wherein the pixel data is Lab pixel data composed of L data, a data, and b data.

4. The image processing apparatus according to claim 1, wherein the pixel data is Yuv pixel data composed of Y data, u data, and v data.

5. The image processing apparatus according to claim 2,
wherein each of the R data, the G data, and the B data is eight-bit string data, and
wherein the address generating unit generates the address data by masking low four bits of each of the R data, the G data, and the B data.

6. The image processing apparatus according to claim 3,
wherein each of the L data, the a data, and the b data is eight-bit string data, and
wherein the address generating unit generates the address data by masking low two bits of the L data and high one bit and low four bits of each of the a data and the b data.

7. The image processing apparatus according to claim 4,
wherein each of the Y data, the u data, and the v data is eight-bit string data, and
wherein the address generating unit generates the address data by masking low two bits of the Y data and low five bits of each of the u data and the v data.

8. The image process apparatus according to claim 1,
wherein the address generating unit includes a bit converting section for converting portion in which the color data included in the pixel data is masked, and
wherein the bit converting unit converts the portion in which the color data included in the pixel data is masked in accordance with a color space of the pixel data.

9. The image processing apparatus according to claim 1, wherein the histogram creating unit creates a three dimensional histogram which is a histogram of each color element of the color data.

10. The image processing apparatus according to claim 9,
wherein the histogram storage memory is divided into a plurality of storage areas corresponding to each color element, and
wherein the histogram creating unit has an access converting section for converting a signal used to specify one storage area to be accessed among the plurality of storage areas, and the histogram creating unit creates the three dimensional histogram by incrementing the number information specified in accordance with the address data generated by the address generating unit and the signal converted by the access converting section.
